(19) United States
(12) Patent Application Publication
(10) Pub. No.: US 2009/0185698 A1
(43) Pub. Date: Jul. 23, 2009

(54) Structure of an andio device

(75) Inventors: Zhi-Jian Liao, Taipei (TW); Guo-Rui Han, Taipei (TW)

Correspondence Address: BACON & THOMAS, PLLC, 625 SLATERS LANE, FOURTH FLOOR, ALEXANDRIA, VA, 22314-1176, US

(73) Assignee: KYE SYSTEMS CORP., TAIPEI (TW)

(21) Appl. No.: 12/071,744

(22) Filed: Feb. 26, 2008

(30) Foreign Application Priority Data
Jan. 18, 2008 (TW) 097102103

(51) Int. Cl. H04R 23/00

(52) U.S. Cl. 381/150

(57) ABSTRACT

An audio device or system includes a housing which accommodates a circuit board having a micro control unit located within the housing, at least a speaker, and at least an optical trace detecting module coupled to the micro control unit. The optical trace detecting module at least has a light source and an image sensor for detecting a movement of a user's finger moving thereon so as to generate a corresponding moving signal, which is supplied to the micro control unit to cause the micro control unit to generate a control signal for adjusting a received audio signal. The micro control unit may be used in place of a rotary audio adjustment button or knob.

### BACKGROUND OF THE INVENTION

1. Field of the Invention

The present invention relates to an audio device, and in particular to a unique structure and control method of an audio device.

2. Description of the Prior Art

Common audio devices, such as a speaker system, earphone, CD/DVD player, usually have several control buttons to enable tuning and/or adjustment of the volume, bass, treble . . . etc . . . for obtaining a comfortable listening quality. The variety of buttons positioned on the control panel of the audio device have a profound effect on the overall design of the audio device, and in particular its outline.

This is particularly true of a regular rotary control button or knob, which needs to prominently protrude from the control panel of the audio device in order to enable operation of the button or knob, and therefore can detract from the visually friendly effect of a flat control panel.

### SUMMARY OF THE INVENTION

It is accordingly an object of the present invention to provide a structure of an audio device that provides a more aesthetically pleasing appearance, and in particular that eliminates the need for a protruding control button or knob and therefore provides a flatter, more uniform control panel.

To accomplish the advantage mentioned above, the invention comprises a housing which accommodates a circuit board having a micro control unit located within the housing, at least one speaker, and at least an optical trace detecting module coupled to the micro control unit. The optical trace detecting module at least has a light source and an image sensor for detecting a movement of a user's finger moving thereon, and is arranged to generate and transmit a corresponding moving signal to the micro control unit, which the micro control unit uses to generate a first control signal for adjusting characteristics or properties of an audio signal supplied to the speaker.

### BRIEF DESCRIPTION OF THE DRAWINGS

FIG. 1 is an exploded isometric view of a first preferred embodiment of the present invention.

FIG. 2 is an isometric view of the first embodiment.

FIG. 3 is a block diagram of the first embodiment.

FIG. 4 is an exploded isometric view of the second preferred embodiment of the present invention.

FIG. 5 is a perspective view of the second embodiment.

FIG. 6 is a cross-sectional side view of the second embodiment

FIG. 7 is a block diagram of the second embodiment.

FIG. 8 is an isometric view of a third preferred embodiment of the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The audio device or audio system includes but is not limited to a speaker, stereo system, earphone, or multimedia player.

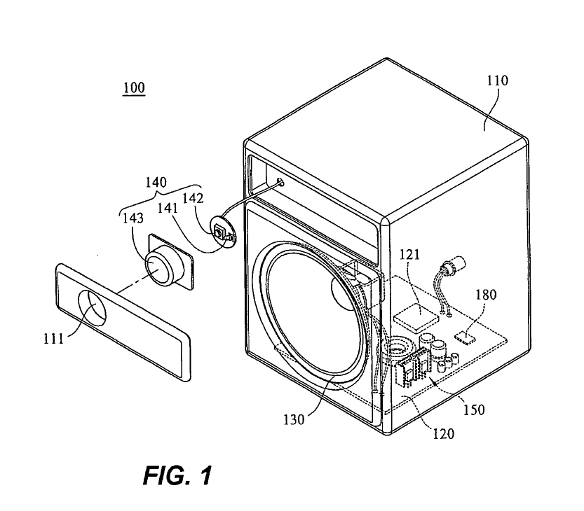

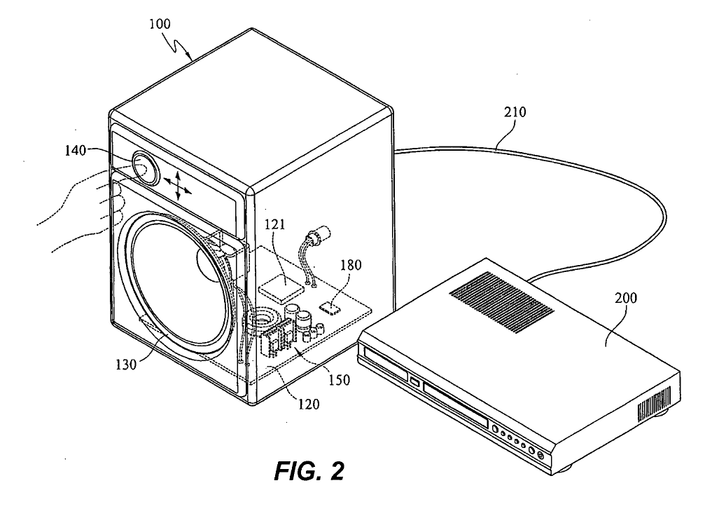

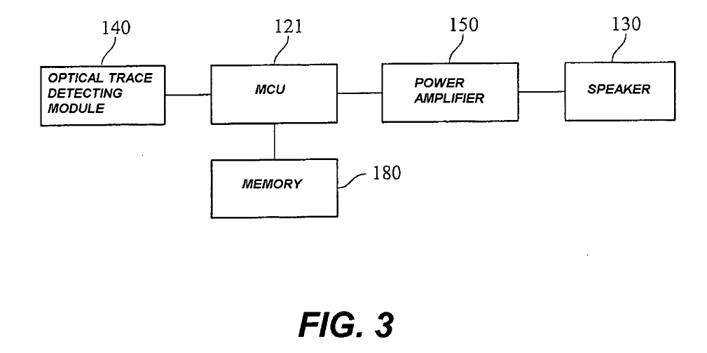

FIGS. 1-3 illustrate the first embodiment of the present invention. The audio device 100, such as a speaker system, may be coupled to a player 200 through a cable 210 for receiving an audio signal. The audio device 100 generally has a housing 110, a circuit board 120, a speaker 130, and a power amplifier 150 according to the prior art. The audio device 100 further has an optical trace detecting module 140 which is coupled to a micro control unit (MCU) 121 and generates a moving signal to indicate detected movements. Once the MCU 121 receives an appropriate moving signal generated by optical trace detecting module 140, the MCU 121 will output a first control signal so as to modify the sound broadcast by the speaker, i.e., the audio signal supplied to the speaker is adjusted based on the moving signal. The adjustment may correspond to mode settings stored in the memory 180 and correlated to movement direction or pattern, as explained below.

The optical trace detecting module 140 has a light source 141, an image sensor 142, and a light transmitting element 143. The light transmitting element 143 can be a lens that is accessible or protrudes through an opening 111.

By way of example and not limitation, specific movements of a user's finger across the light transmitting element 143 may be correlated to particular audio mode settings/controls as follows: When a user moves his finger upon the light transmitting element 143 in an upward direction, the volume of the sound may be turned up. On the other hand, when the user moves his finger upon the light transmitting element 143 in a downward direction, the volume of the sound may be turned down. When the user moves his finger upon the light transmitting element 143 is a leftward direction, the bass of the sound may be turned up. Finally, when the user moves his finger upon the light transmitting element 143 in a rightward direction, the treble of the sound may be turned up as well. Furthermore, when the user moves his finger upon the light transmitting element 143 according to a specific pattern, such as a curve, circle, spiral, or figure “8.”, a booster (loudness) sound effect may be activated. However, if the user reverses his previous finger movement, the sound effect can be canceled.

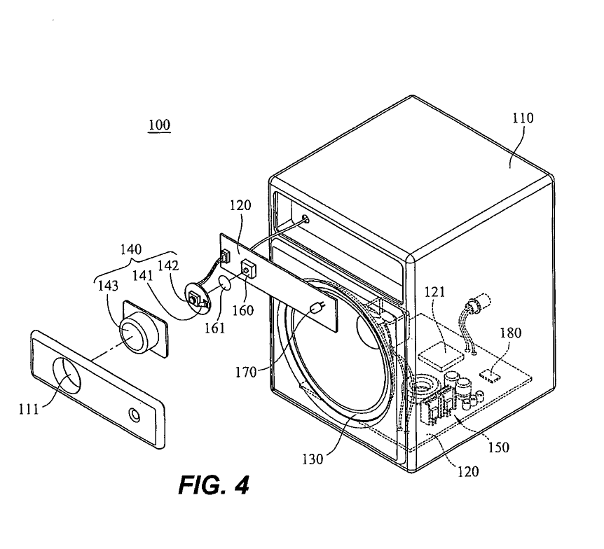

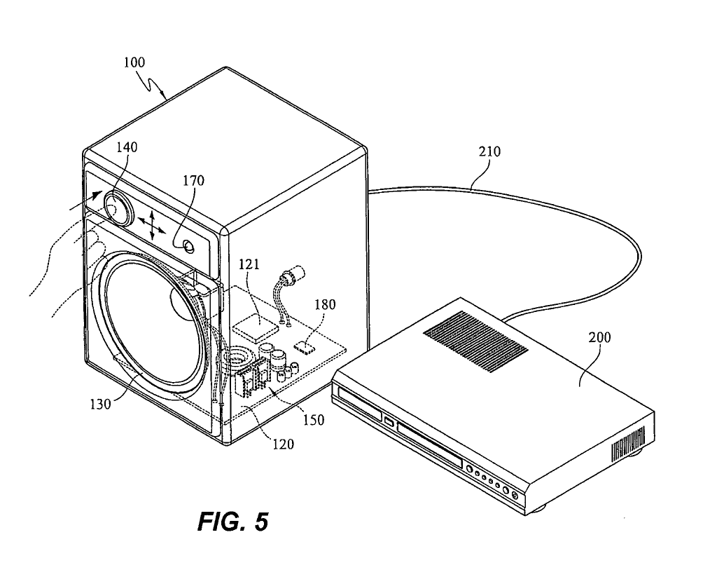

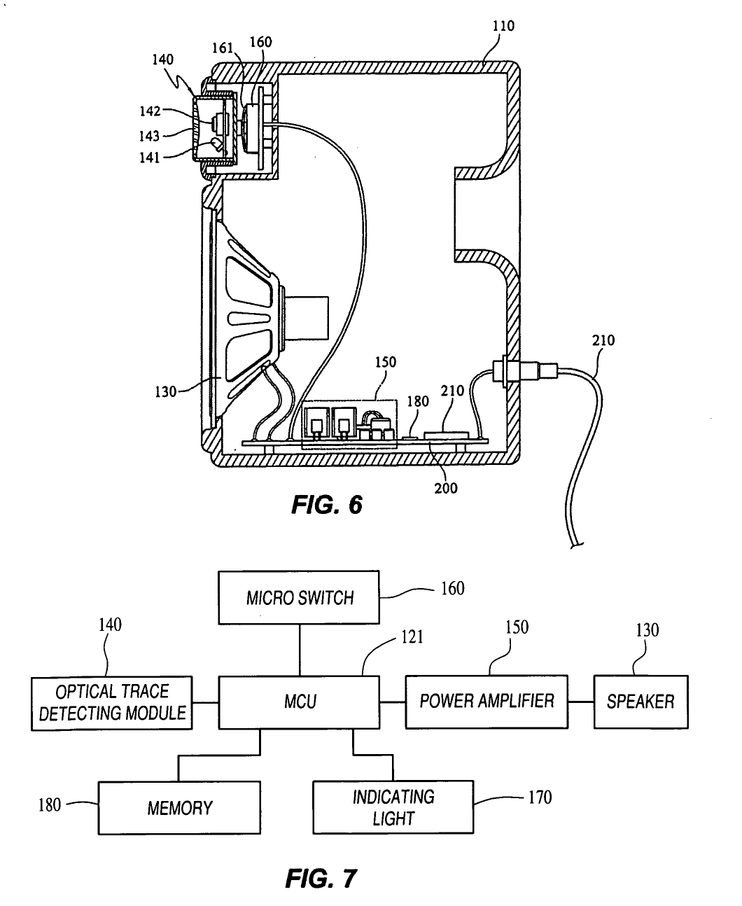

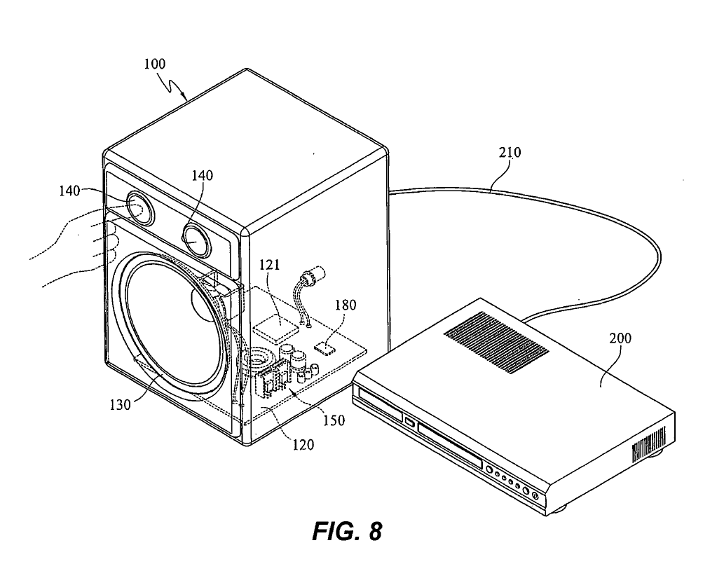

FIGS. 4-7 illustrate a second embodiment of the present invention. This embodiment differs from the first embodiment in that it includes a micro switch 160 on the circuit board 120 that is positioned next to the optical trace detecting module 140, such that the when the user pushes the optical trace detecting module 140 toward the housing 110, the micro switch will be activated and the MCU 121 generates a second control signal. One end of a power amplifier 150 connects to the MCU 121 while the other end of the amplifier 150 connects to the speaker 130. For example, when the user pushes in the optical trace detecting module 140 by pushing on the light transmitting element 143, a booster (“loudness” or enhanced bass) sound effect may be directly activated and an indicating light 170 will be activated. If the user pushes the light transmitting element 143 again, the sound effect can be canceled immediately and the indicating light 170 will be dim. It is understood that the optical trace detecting module 140 and the micro switch 160 can be assembled as a single unit. Alternatively, referring to FIG. 8, the optical trace detecting module 140 can be installed as more than just one unit. For example, one unit may control the volume of the speaker, while the other one controls the bass and treble.

Because the light source 141 always projects a light beam at the light transmitting element 142, an attractive visual effect may be obtained, particularly if the light transmitting element is translucent.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A structure of an audio device for receiving an audio signal, comprising:
a housing accommodating a circuit board, at least a speaker, and at least an optical trace detecting module;
wherein the circuit board has a micro control unit and a memory; the speaker is coupled to the circuit board; and the optical trace detecting module is coupled to the micro control unit;
wherein the optical trace detecting module at least has a light source and a image sensor for detecting a user's finger moving thereon so as to generate a corresponding moving signal, which is supplied to the micro control unit;
whereby, in response to the moving signal, the micro control unit generates a first control signal for adjusting the audio signal.

2. The audio device structure as claimed in claim 1, wherein the light optical trace detecting module is movable, and a micro switch is next to the optical trace detecting module; wherein the micro switch generates a second control signal when the detecting module is pushed by the user.

3. The audio device structure as claimed in claim 1, wherein the top of the optical trace detecting module further has a light transmitting element for placing the user's finger.

4. The audio device structure as claimed in claim 1, wherein movement of the user's finger in opposite first and second directions controls volume and movement of the user's finger in opposite second and third directions controls bass and treble.

5. The audio device structure as claimed in claim 4, wherein movement of the user's finger in multiple directions according to a predetermined pattern activates a loudness function.

6. The audio device structure as claimed in claim 4, wherein pushing on the optical trace detecting module activates a loudness function.

7. The audio device structure as claimed in claim 4, wherein movement of the user's finger in an opposite direction cancels a previous volume or bass/treble adjustment.

8. An audio system, comprising:
a housing accommodating a circuit board and an optical trace detecting module;
wherein the circuit board has a micro control unit and a memory; the optical trace detecting module being coupled to the micro control unit;
wherein the optical trace detecting module has a light source and an image sensor for detecting an movement of a user's finger thereon so as to generate a corresponding moving signal, which is supplied to the micro control unit to cause the micro control unit to generate a first control signal for adjusting an audio signal supplied to a speaker.

9. The audio system as claimed in claim 8, wherein the light optical trace detecting module is movable, and a micro switch is next to the optical trace detecting module; wherein the micro switch generates a second control signal when the detecting module is pushed by the user.

10. The audio system as claimed in claim 8, wherein the top of the optical trace detecting module further has a light transmitting element for placing the user's finger.

11. The audio system as claimed in claim 8, wherein movement of the user's finger in opposite first and second directions controls volume and movement of the user's finger in opposite second and third directions controls bass and treble.

12. The audio system as claimed in claim 11, wherein movement of the user's finger in multiple directions according to a predetermined pattern activates a loudness function.

13. The audio system as claimed in claim 11, wherein pushing on the optical trace detecting module activates a loudness function.

14. The audio system as claimed in claim 11, wherein movement of the user's finger in an opposite direction cancels a previous volume or bass/treble adjustment.

15. A method for adjusting an audio signal, comprising:
providing a housing for accommodating a circuit board and at least an optical trace detecting module;
causing the optical trace detecting module to detect movement of a user's finger thereon so as to generate a corresponding moving signal and supplying the moving signal to a micro control unit of the circuit to cause the micro control unit to generate a first control signal for adjusting the audio signal;
moving the optical trace detecting module relative to the housing so as to cause a micro switch next to the optical trace detecting module to generate a second control signal.
